(19) United States
(12) Patent Application Publication
(10) Pub. No.: US 2023/0028583 A1
(43) Pub. Date: Jan. 26, 2023

(54) PROTECTIVE POLYAMIDE FILM FOR TAPE MEASURES

(71) Applicant: DuPont Teijin Films U.S. Limited Partnership, Wilmington, DE (US)

(72) Inventors: Shengsheng Liu, Chester, VA (US); Erik Nelson, Chester, VA (US)

(73) Assignee: DuPont Teijin Films U.S. Limited Partnership, Wilmington, DE (US)

(21) Appl. No.: 17/782,720

(22) PCT Filed: Dec. 17, 2020
(86) PCT No.: PCT/IB2020/062096

§ 371 Date: Jun. 6, 2022

(30) Foreign Application Priority Data
Dec. 20, 2019 (GB) 1918952.1

(51) Int. Cl. G01B 3/1003; B32B 15/088; B32B 15/18

(52) U.S. Cl. CPC G01B 3/1003; B32B 15/088; B32B 15/18; B32B 2307/732; B32B 2255/10; B32B 2255/26; B32B 2250/02; B32B 2307/584

(57) ABSTRACT

The invention is concerned with a blade for a tape measure, wherein the blade comprises an elongate metal substrate and further comprises at least one oriented polyamide protective film. The oriented polyamide protective film comprises an oriented polyamide substrate film and may comprise a heat-sealable polymeric coating layer.

The present invention relates to the field of protective films for tape measures, to the tape measures made therefrom, as well as to a method of making said tape measures.

A typical tape measure consists of a flexible tape or blade that is wound on a reel within a housing. The blade is stored in the housing in a wound state and it is unwound and extended from the housing to measure distances, usually linear distances. The blade can be rewound back into the housing either manually, such as by rotating an external crank, or automatically, such as by use of an internal spring. The blade is usually made of a thin strip of sheet metal, typically steel. The blade displays measurement indicia printed on a surface thereof such that when the blade is extended from the housing a user can measure distances by reading the indicia. Typically, a pigment or paint layer is disposed on the surface of the blade prior to printing the measurement indicia, in order to enhance the legibility of the indicia. Typically, the pigmented layer is yellow or white and the measurement indicia are printed in dark ink.

Repeated winding and unwinding of the blade causes the printed material on the blade to contact and wear against any surface it contacts. Spring-loaded tape measures are particularly prone to wear since the speed of the blade as it retracts into the housing causes it to “whip” against the housing. In addition, tape measures are subject to use on constructions sites where they are used outdoors in all types of weather and under abrasive conditions. Accordingly, as the tape measure is used over time, the printed indicia often wears off, making the indicia difficult or impossible to read, leading to inaccuracies in measurement and unacceptable performance of the tape measure. Typically, the printed material wears away before the other structural elements of the tape measure fail, which is frustrating for the user and gives the impression that the tape measure is of poor quality. In addition, the reverse surface of the tape measure (referred to herein as the lower surface) may also become abraded as it is moved across the substrate to be measured and into the aperture of the tape housing during extension and retraction, and this is a particular problem for the swift retraction of spring-loaded tape measures. The housing typically comprises guide nodules to encourage reliable retraction and rewinding of the tape, and abrasion of the tape surface as it moves across these guide nodules is a particular problem. The reverse (lower) surface of the tape optionally also exhibits measurement indicia.

Various attempts have been made to provide a tape measure having a blade with improved wear characteristics. US-2007/0079520-A discloses a transparent protective film made of polyester, polyethylene, polyurethane, polypropylene or nylon which has the measurement indicia printed on the inner surface thereof, i.e. the surface which faces the blade. The film is reported as having a thickness of 0.001 to 0.015 inches (25.4 to 381 μm) and is attached to the blade by an adhesive such as silicone or acrylic. The printed protective film may extend over the upper or lower surface of the blade. A further embodiment is disclosed in which indicia are required on both surfaces, and so the printed film extends over both surfaces of the blade, optionally wherein a single film is use to cover the entirety of both surfaces by wrapping around one edge. The present inventors have also considered using a laminated composite film as the protective film on an indicia-bearing surface of the metal substrate, wherein the laminated composite film comprises a nylon layer which forms the external surface of the finished tape and a polyester layer which faces the indicia-bearing metal substrate wherein the laminated composite film is manufactured in an off-line lamination process; however, such a manufacturing process disadvantageously increases the cost of manufacture.

While such arrangements improve the wear characteristics of the printed indicia, the wound reel of tape and the housing in which it is contained becomes very bulky. It would be desirable to decrease the thickness of the measuring tape while providing excellent abrasion resistance characteristics, particularly wherein abrasion resistance is required on both surfaces of the tape. It would also be desirable to avoid the manufacture of multiple different housings for tape measures of different length, and instead manufacture a single housing which is not too bulky (and therefore more convenient to use and store) and which has a size that is independent of the length of the tape measure, thereby improving efficiency and economy of manufacture, and convenience of use and storage.

A further problem with conventional measuring tapes, such as those disclosed in US-2007/0079520-A, is delamination of the protective film from the metal blade, since the blade is not fully protected by the protective film, and particularly because one or both seals between blade and film is exposed to the environment and mechanical stress, which decreases the durability of the measuring tape. It would be desirable to improve the delamination resistance of the protective film.

It is an object of the invention to overcome one or more of the afore-mentioned problems.

According to a first aspect of the present invention there is provided a blade for a tape measure comprising an elongate metal substrate having an upper surface and a lower surface, wherein measurement indicia are disposed on at least one of said upper and lower surfaces, wherein said blade further comprises an oriented polyamide protective film disposed on at least one of said upper and lower surfaces, wherein the oriented polyamide protective film comprises an oriented polyamide substrate layer and a heat-sealable polymeric coating layer, and wherein the thickness of said oriented polyamide protective film is no more than 75 μm.

It will be appreciated that the metal substrate is an elongate lamina having first and second ends and two lateral edges. The first end is secured within a housing for retaining the blade. The second end extends or projects from the housing. In use the second end is extended from the housing to measure a distance using the measurement indicia.

Similarly, it will be appreciated that said protective film is an elongate lamina having first and second ends and two lateral edges. It will further be appreciated that said oriented polyamide protective film extends across the entire surface area of an indicia-bearing surface of the metal substrate. Preferably, the entire surface area of the upper and lower surfaces of said metal substrate is covered by protective film.

The metal substrate may be made of steel or other flexible metallic material (i.e. metals and metal-based alloys). The substrate should be sufficiently flexible be wound around a hub within the housing to form a reel yet strong enough to extend a significant unsupported distance from the housing without buckling. Typically, blades exhibit a curved transverse profile in the extended position for that reason. The strip of metal substrate is typically slightly longer than the desired working length of the tape measure to account for the length of material that is attached to the hub and remains in the housing even when the blade is in its fully extended position.

The measurement indicia are suitably disposed on the metal substrate by printing, according to conventional techniques well known to the person skilled in the art of manufacturing tape measures. The measurement indicia are usually printed in dark ink, preferably black ink. A pigment or paint layer, typically a yellow or white layer for maximum contrast with the dark ink, is typically disposed on the metal substrate prior to application of the measurement indicia. The oriented polyamide protective film preferably does not exhibit measurement indicia thereon.

The polyamide of said oriented polyamide protective film may be any suitable film-forming thermoplastic polyamide. Synthetic linear polyamides are preferred. The polyamide should be crystallisable. Suitable polyamides include homopolymers or copolymers selected from aliphatic polyamides and aliphatic/aromatic polyamides, particularly aliphatic polyamides. Useful polyamide homopolymers include poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid) (nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), nylon 4,6, poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12) and the like. Useful aliphatic polyamide copolymers include caprolactam/hexamethylene adipamide copolymer (nylon 6,6/6), hexamethylene adipamide/caprolactam copolymer (nylon 6/6,6), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6) and the like. Examples of aliphatic/aromatic polyamides include poly(tetramethylenediamine-co-isophthalic acid) (nylon 4,1), polyhexamethylene isophthalamide (nylon 6,1), hexamethylene adipamide/hexamethylene-isophthalamide (nylon 6,6/6I), hexamethylene adipamide/hexamethylene-terephthalamide (nylon 6,6/6T), poly(2,2,2-trimethyl hexamethylene terephthalamide), poly(m-xylylene adipamide) (MXD6), poly(p-xylylene adipamide), poly(hexamethylene terephthalamide), poly(dodecamethylene terephthalamide), polyamide 6T/6I, polyamide 6/MXDT/I, polyamide MXDI, and the like.

Preferred polyamides are linear aliphatic polyamides, preferably selected from: nylon 6,6; nylon 6; nylon 6.66; nylon 6,10; nylon 6,4; and blends and mixtures thereof. Nylon 6,6 is particularly preferred.

The oriented polyamide substrate layer of the oriented polyamide protective film preferably forms an exterior surface of the blade of the tape measure, thereby protecting the tape, and particularly the measurement indicia thereon, from wear.

The thickness of said oriented polyamide protective film is preferably no more than 50 μm, preferably no more than 25.0 μm, preferably no more than 20 μm, preferably no more than 15 μm, preferably no more than 12.5 μm.

The oriented polyamide protective film is a self-supporting film or sheet by which is meant a film or sheet capable of independent existence in the absence of a supporting base. The oriented polyamide protective film is uniaxially or biaxially oriented, preferably biaxially oriented. It will be appreciated by those skilled in the art that the oriented polyamide protective film is categorised as a semi-crystalline film.

Formation of the oriented polyamide protective film may be effected by conventional techniques well-known in the art. Conveniently, formation of the substrate is effected by extrusion. In general terms the process comprises the steps of extruding a layer of molten polymer at elevated temperature (typically in the range of 250-265° C. for nylon 6), quenching the extrudate and orienting the quenched extrudate by drawing in at least one direction. Orientation may be effected by any process known in the art for producing an oriented film, for example a tubular or flat film process. Biaxial orientation is effected by drawing in two mutually perpendicular directions in the plane of the film to achieve a satisfactory combination of mechanical and physical properties. In a tubular process, simultaneous biaxial orientation may be effected by extruding a thermoplastics polyamide tube which is subsequently quenched, reheated and then expanded by internal gas pressure to induce transverse orientation, and withdrawn at a rate which will induce longitudinal orientation. Suitable simultaneous biaxial orientation processes are disclosed in EP-2108673-A and US-2009/0117362-A1, the disclosure of which processes is incorporated herein by reference.

In the preferred flat film process, the film-forming polymer is extruded through a slot die and rapidly quenched upon a chilled casting drum to ensure that the polymer is quenched to the amorphous state. Orientation is then effected by stretching the quenched extrudate in at least one direction at a temperature above the glass transition temperature of the polymer. Sequential orientation may be effected by stretching a flat, quenched extrudate firstly in one direction, usually the longitudinal direction, i.e. the forward direction through the film stretching machine, and then in the transverse direction. Forward stretching of the extrudate is conveniently effected over a set of rotating rolls or between two pairs of nip rolls, transverse stretching then being effected in a stenter apparatus.

Stretching is generally effected so that the dimension of the oriented film is from 2 to 8, more preferably 2.5 to 5 times its original dimension in the or each direction of stretching. Stretching is conventionally effected at temperatures higher than the T_{g} of the polymer composition, preferably at least about 5° C. higher, preferably at least about 15° C. higher than the T_{g}, and preferably in the range of from about T_{g}+5° C. to about T_{g}+75° C., preferably from about T_{g}+5° C. to about T_{g}+30° C. It is not necessary to stretch equally in the machine and transverse directions although this is preferred if balanced properties are desired.

A stretched film may be, and preferably is, dimensionally stabilised by heat-setting under dimensional support at a temperature above the glass transition temperature of the polymer but below the melting temperature thereof, to induce the desired crystallisation of the polymer. The actual heat-set temperature and time will vary depending on the composition of the film and its desired final thermal shrinkage but should not be selected so as to substantially degrade the toughness properties of the film such as tear resistance. Within these constraints, heat-setting is typically conducted at a temperature from about 80° C. less than the melting temperature of the film (i.e. T_{M}−80° C.) to about 10° C. less than T_{M} (i.e. T_{M}−10° C.), preferably from at least about T_{M}−70° C., preferably from at least about T_{M}−60° C., preferably from at least about T_{M}−50° C., preferably to about T_{M}−20° C.

The stretched film is then cooled in order induce the desired crystallinity of the polymer.

The film-forming polymer may comprise any other additive conventionally employed in the manufacture of polymer films. Thus, agents such as particulate fillers, hydrolysis stabilisers, anti-oxidants, UV-stabilisers, cross-linking agents, dyes, lubricants, radical scavengers, thermal stabilisers, surface active agents, gloss improvers, prodegradents, viscosity modifiers and dispersion stabilisers may be incorporated as appropriate. Of particular utility are particulate fillers, which improve handling and windability during manufacture and/or modulate optical properties, as is well known in the art. The particulate filler is typically a particulate inorganic filler (e.g. metal or metalloid oxides, such as alumina, titania, talc and silica (especially precipitated or diatomaceous silica and silica gels), calcined china clay and alkaline metal salts, such as the carbonates and sulphates of calcium and barium). Other slip-aids or anti-blocking agents which improves the handling of the film include paraffin wax, carnauba wax, kemamide and other long-chain aliphatic amides. Particulate inorganic fillers and other slip aids are present in relatively minor amounts, typically less than 5.0 wt %, typically less than 2.0 wt %, typically less than 1.0 wt %. The film-forming polyamide preferably constitutes at least 80%, preferably at least 85%, preferably at least 90%, preferably at least 95%, typically at least 98% or at least 99% of the film layer which it forms.

The oriented polyamide protective film comprises an oriented polyamide substrate layer as hereinbefore described and a heat-sealable polymeric coating layer thereon. The polymeric material of the heat-sealable polymeric coating layer is capable of softening to a sufficient extent on heating that its viscosity becomes low enough to allow adequate wetting for it to adhere to the surface to which it is being bonded.

As used herein, the term “heat-sealable” refers to the ability to form a heat-seal bond by contacting the heat-sealable film with the surface to which it is to be bonded at a temperature of no more than 250° C. (preferably no more than 230° C., and preferably within the range of 150 to 200° C.) and a pressure of no more than about 1000 kPa (preferably no more than 700 kPa, preferably no more than 550 kPa, preferably no more than 210 kPa) for a time of no more than 5 seconds (preferably no more than 1 second, preferably no more than 0.3 seconds), preferably wherein the resulting bond strength is at least 10 g/mm, preferably at least 20 g/mm, preferably at least 30 g/mm).

The heat-sealable polymeric coating may be formed from any polymeric material suitable as a heat-sealable coating on a polyamide substrate. Suitable heat-sealable polymeric coatings include polyvinylidene chloride (PVDC), ethylene vinyl acetate (EVA), polyolefins, ethylene-acrylic acid copolymers, ethylene-methacrylic acid copolymers and copolyesters. EVA and PVDC coatings are particularly preferred, and especially EVA coatings.

A preferred EVA heat-sealable coating is suitably formed from EVA polymers commercially available as Elvax™ resins (DuPont). Typically, the EVA resin has a vinyl acetate content in the range of 9% to 40%, and typically 15% to 30%.

PVDC heat-sealable coatings are well known in the art, and suitable PVDC materials are copolymers of vinylidene chloride with other monomers. A vinylidene chloride copolymer is typically obtained as a latex dispersed in a medium by polymerizing using conventional emulsion polymerization methods 50 to 99% by mass of vinylidene chloride as a starting material and 1 to 50% by mass of one or more other monomers copolymerizable with vinylidene chloride. The higher the proportion of vinylidene chloride, the higher the crystalline melting point of the vinylidene chloride copolymers. Examples of the copolymerizable monomer include: vinyl chloride; acrylic acid esters such as methyl acrylate, ethyl acrylate, butyl acrylate, 2-ethylhexyl acrylate and 2-hydroxyethyl acrylate; methacrylic acid esters such as methyl methacrylate and glycidyl methacrylate; acrylonitrile and methacrylonitrile; and unsaturated carboxylic acids such as acrylic acid, methacrylic acid, itaconic acid and maleic acid. One or two or more of such monomers may be used. The solid content concentration of the vinylidene chloride copolymer mixture latex can be appropriately altered according to the specifications of the coating apparatus or the drying-heating apparatus, and is preferably in a range from 10 to 70% by mass and more preferably in a range from 30 to 55% by mass.

Suitable copolyesters for the heat-sealable coating include copolyesters derived from an aromatic dicarboxylic acid and an aliphatic dicarboxylic acid, particularly those of the general formula CₙH₂ₙ(COOH)₂ wherein n is 2 to 8, and one or more diol(s). A preferred aromatic dicarboxylic acid is terephthalic acid. Preferred aliphatic dicarboxylic acids are selected from sebacic acid, adipic acid and azelaic acid. The concentration of the aromatic dicarboxylic acid present in the copolyester is preferably in the range from 45 to 80, more preferably 50 to 70, and particularly 55 to 65 mole % based on the dicarboxylic acid components of the copolyester. The concentration of the aliphatic dicarboxylic acid present in the copolyester is preferably in the range from 20 to 55, more preferably 30 to 50, and particularly 35 to 45 mole % based on the dicarboxylic acid components of the copolyester. Preferred diols are aliphatic diols, particularly ethylene glycol or butylene glycol. It will be appreciated that the preferred heat-sealable copolyesters are thermoplastic linear copolyesters. Particularly preferred examples of such copolyesters are (i) copolyesters of azeleic acid and terephthalic acid with an aliphatic glycol, preferably ethylene glycol; (ii) copolyesters of adipic acid and terephthalic acid with an aliphatic glycol, preferably ethylene glycol; and (iii) copolyesters of sebacic acid and terephthalic acid with an aliphatic glycol, preferably butylene glycol. Preferred polymers include a copolyester of sebacic acid/terephthalic acid/butylene glycol (preferably having the components in the relative molar ratios of 45-55/55-45/100, more preferably 50/50/100) having a glass transition point (Tg) of −40° C. and a melting point (Tm) of 117° C.), and a copolyester of azeleic acid/terephthalic acid/ethylene glycol (preferably having the components in the relative molar ratios of 40-50/60-50/100, more preferably 45/55/100) having a Tg of −15° C. and a Tm of 150° C. A suitable heat-sealable copolyester is Mor-Ester 49002 (Dow Chemical)

Formation of the heat-sealable coating is effected by coating a coating formulation on to the polyamide substrate. Coating may be effected using any suitable coating technique, typically roll coating, and including gravure roll coating and reverse roll coating. Coating may be conducted “off-line”, i.e. after stretching and any subsequent heat-setting employed during manufacture of the polymer substrate, or “in-line”, i.e. wherein the coating step takes place before, during or between any stretching operation(s) employed. The coating formulation is preferably applied to the substrate at a coat weight of from about 0.5 g/m² to about 10 g/m², typically no more than about 5 g/m².

The heat-sealable polymeric coating may comprise any of the additives conventionally used in sealant coatings, particularly anti-blocking agents such as the aforementioned particulate inorganic fillers and organic slip aids, which are usually present in relatively minor amounts, typically less than 5.0 wt %, typically less than 2.0 wt %. The heat-sealable coating may further comprise one or more surfactant(s) to improve the wetting of the substrate. Examples of suitable surfactants include: anionic surfactants such as polyethylene alkyl phenyl ether, polyoxyethylene-fatty acid ester, glycerin fatty acid ester, sorbitan fatty acid ester, fatty acid metal soaps, alkyl sulfuric acid salts, alkylsulfonic acid salts and alkylsulfosuccinic acid slats; and nonionic surfactants such as acetylene glycol. The heat-sealable polymeric material preferably constitutes at least 90%, preferably at least 95%, typically at least 98% of the coating layer which it forms.

The components of the heat-sealable polymeric coating are typically dispersed or dissolved in a coating vehicle, which may be water or an organic solvent or a mixture thereof. The coating formulation preferably comprises the coating vehicle in an amount of from 10 to 30, preferably 15 to 20 wt % of the coating formulation.

Prior to application of the heat-sealable coating onto the polymer surface, the exposed surface of the polymeric substrate may, if desired, be subjected to a chemical or physical surface-modifying treatment to improve the bond between that surface and the subsequently applied heat-sealable coating. For example, the exposed surface of the polymeric substrate may be subjected to a high voltage electrical stress accompanied by corona discharge. Preferably, the polymeric substrate is coated with a primer coating layer prior to application of the heat-sealable coating layer.

The primer coating layer is suitably constituted by a polymeric material and is any material which improves the adhesion bond strength between the polyamide and the subsequently applied heat-sealable polymeric layer. Suitable primer coatings include polyurethanes (PU), polyethyleneimines (PEI) and PVDC. The primer coating composition is preferably an aqueous composition. Suitable polyurethanes are derived from a polyol or mixture of polyols containing acidic functionality which will allow crosslinking, and an aliphatic diisocyanate, wherein suitable polyols include polyether polyols grafted with, for example, maleic or fumaric acid, as taught in U.S. Pat. Nos. 4,460,738 and 4,528,334, or mixtures of a polyol free of acid functionality with an acid-functional compound which also has hydroxyl, amine or thiol functionality; and suitable isocyanates include m-tetramethylxylene diisocyanate or p-tetramethylxylene diisocyanate. Suitable polyurethanes are described in U.S. Pat. No. 5,494,960, the disclosure of which is incorporated herein by reference. Suitable PVDC copolymers are disclosed in U.S. Pat. No. 4,438,180 and EP-2216173-A, the disclosures of which are incorporated herein by reference.

The primer coating layer may be applied to the polyamide substrate using the coating techniques described hereinabove. The primer coating is typically applied using a solvent vehicle, including using an aqueous solution. The primer is usually coated on the polyamide substrate via an inline technique.

The thickness of the heat-sealable polymeric coating layer is preferably from about 0.5 to about 5.0 μm, preferably from 1.0 to about 4.0 μm. The thickness of the optional primer layer is preferably no more than 1 μm, preferably no more than about 0.5 μm, preferably no more than about 0.3 μm, preferably at least 0.05 μm, and typically about 0.1 μm.

Thus, in a preferred embodiment, the oriented polyamide protective film comprises, preferably consists essentially of, and preferably consists of, an oriented polyamide substrate layer, an optional primer coating layer and a heat-sealable polymeric coating layer. The oriented polyamide protective film is preferably disposed on the elongate metal substrate such that the oriented polyamide substrate layer forms the exterior surface of the blade of the tape measure, i.e. the oriented polyamide layer is exposed to the environment in use, and the heat-sealable layer is innermost, i.e. it faces an indicia-bearing surface of the metal substrate.

It will be appreciated that the multilayer oriented polyamide protective film as described hereinabove is not made by a lamination process, but by a coating process. Thus, the heat-sealable polymeric coating layer and optional primer layer are disposed on said polyamide substrate layer by a coating technique, rather than by a lamination technique. Advantageously, this reduces the thickness of the protective film, and hence the thickness of the blade of the tape measure, and hence the size of the housing.

The blade of the tape measure is manufactured by laminating the oriented protective film to the elongate metal substrate on an indicia-bearing surface thereof. The lamination is effected by contacting the oriented protective film and an optionally indicia-bearing and optionally pigmented surface of the metal substrate under conditions of elevated heat and pressure, preferably at a temperature of no more than 250° C. (and preferably within the range of 150 to 200° C.) and a pressure of no more than about 1000 kPa (preferably no more than 700 kPa, preferably no more than 550 kPa, preferably no more than 210 kPa) for a time of no more than 1 seconds (and preferably no more than 0.3 seconds). Any suitable laminating device may be used. Where an oriented protective film is disposed on each of the upper and lower surfaces of the blade, it is preferred that a single lamination step is used to laminate the assembly.

A layer of adhesive is preferably interposed between the oriented protective film and the elongate metal substrate. The adhesive may be applied to the oriented protective film or to the metal substrate prior to lamination. Any suitable adhesive conventional in the art may be used, preferably an aqueous-based adhesive, for instance copolyester or polyurethane adhesives. The thickness of the adhesive layer is preferably in the range of from 5 to 10 μm.

Thus, where an adhesive layer is present on an indicia-bearing surface of the blade, the layer order of the blade of the tape measure is as follows, starting from the exterior surface: oriented protective film/adhesive layer/indicia-bearing and optionally pigmented surface of the metal substrate. It will be appreciated that no intervening layers are present between the oriented protective film and the adhesive layer or between the adhesive layer and the indicia-bearing and optionally pigmented surface of the metal substrate. Where no adhesive layer is present, there is no intervening layer between the oriented protective film and the indicia-bearing and optionally pigmented surface of the metal substrate.

It will be appreciated that said adhesive layer(s) are suitably co-terminous with the elongate metal substrate and/or the oriented protective film.

The blade preferably comprises a first oriented protective film on the upper surface of the elongate metal substrate and a second oriented protective film on the lower surface of the elongate metal substrate. Both the upper and lower surfaces are preferably pigmented. At least one of the upper and lower surfaces bear measurement indicia. According to the present invention, at least one of said first and second oriented protective films is selected from the oriented polyamide protective film described hereinabove which comprises an oriented polyamide substrate layer and a heat-sealable polymeric coating layer. Thus, superior abrasion resistance is provided to at least one of the upper and lower surfaces. Preferably, said oriented polyamide protective film is disposed on an indicia-bearing surface.

The other of said first and second oriented protective films may be an oriented polyamide film, preferably the oriented polyamide protective film described hereinabove. In that case, the first and second oriented polyamide protective films may be the same or different, but they preferably have the same composition, and preferably also the same thickness.

Alternatively, one of said first and second oriented protective films is selected from the oriented polyamide protective film described hereinabove, and the other of said first and second oriented protective films is selected from an oriented polyester protective film. Said oriented polyester protective film is preferably a polyethylene terephthalate (PET) film, preferably a biaxially oriented PET film. Said polyester film may be monolayer film or a composite film which comprises a polymeric heat-sealable layer disposed on one or both surface(s) of an oriented polyester substrate layer. In this embodiment, the heat-sealable polymeric layer disposed on the oriented polyester substrate layer is preferably selected from the heat-sealable polymeric layers disclosed hereinabove for the oriented polyamide protective layer, preferably copolyesters, PVDC and EVA, and preferably PVDC.

Preferred embodiments of the first aspect of the invention are described below.

In a first embodiment, the blade is constituted by said elongate metal substrate having measurement indicia disposed on one optionally pigmented surface thereof (referred to herein as the upper surface), a layer of adhesive disposed on said indicia-bearing surface, and said oriented polyamide protective film disposed on said adhesive layer, wherein the heat-sealable polymeric coating layer of said oriented polyamide protective film is in direct contact with said adhesive layer.

In this first embodiment, the blade optionally further comprises a second layer of adhesive, which is disposed on the optionally pigmented and optionally indicia-bearing lower surface of the elongate metal substrate, and a second oriented protective polymeric film disposed on said second adhesive layer. In this configuration, it is preferred that the lateral edges of the second oriented protective polymeric film are co-terminous with the lateral edges of the elongate metal substrate, i.e. the width of the second oriented protective polymeric film is the same as the width of the elongate metal substrate. Thus, advantageously the entire surface area of both upper and lower surfaces of the metal substrate is protected by oriented protective film, in particular by first and second discrete oriented protective films on the respective upper and lower surfaces.

In this first embodiment, said second oriented protective polymeric film is preferably an oriented protective polyamide film as hereinbefore described, wherein the heat-sealable polymeric coating layer of said second oriented polyamide protective film is in direct contact with said second adhesive layer. In that case, the first and second oriented polyamide protective films may be the same or different, but they preferably have the same composition, and preferably also the same thickness. Alternatively, the second oriented protective polymeric film may be a mono-layer oriented polyamide protective film without a polymeric heat-sealable layer. In a further alternative, the second oriented polymeric protective film may be a polyester film, preferably a polyethylene terephthalate (PET) film, preferably a biaxially oriented PET film. Said polyester film may be a mono-layer film or a composite film as described hereinabove which comprises a polymeric heat-sealable layer disposed on one surface of an oriented polyester substrate layer, such that the oriented polyester substrate layer forms the exterior lower surface of the blade of the tape measure, and is exposed to the environment in use, and the polymeric heat-sealable layer is innermost, i.e. it faces the lower surface of the metal substrate.

In this first embodiment, it is preferred that the lateral edges of the or each oriented protective film is/are co-terminous with the lateral edges of the elongate metal substrate, i.e. the width of an oriented protective film is the same as the width of the elongate metal substrate.

In a second embodiment, the blade is constituted by said elongate metal substrate having measurement indicia disposed on the optionally pigmented upper surface thereof, a first layer of adhesive disposed on said indicia-bearing upper surface, a first oriented protective film disposed on said first adhesive layer, a second layer of adhesive disposed on the optionally pigmented and optionally indicia-bearing lower surface of said elongate metal substrate, and a second oriented protective film disposed on said second adhesive layer, wherein said second oriented protective film is an oriented protective polyamide film comprising a heat-sealable polymeric coating layer, wherein said heat-sealable polymeric coating layer of said second oriented polyamide protective film is in direct contact with said second adhesive layer.

In this second embodiment, said first oriented protective polymeric film may be an oriented polyamide protective film as hereinbefore described, wherein the heat-sealable polymeric coating layer of said first oriented polyamide protective film is in direct contact with said first adhesive layer. In that case, the first and second oriented polyamide protective films may be the same or different, but they preferably have the same composition, and preferably also the same thickness. Alternatively, the first oriented protective polymeric film may be a mono-layer oriented polyamide protective film without a polymeric heat-sealable layer. In a further alternative, the first oriented polymeric protective film may be a polyester film, preferably a polyethylene terephthalate (PET) film, preferably a biaxially oriented PET film. Said polyester film may be a mono-layer film or a composite film which comprises a polymeric heat-sealable layer as described hereinabove disposed on one surface of an oriented polyester substrate layer, such that the oriented polyester substrate layer forms the exterior upper surface of the blade of the tape measure, and is exposed to the environment in use, and the polymeric heat-sealable layer is innermost, i.e. it faces the upper surface of the metal substrate.

In this second embodiment, it is preferred that the lateral edges of each oriented protective film are co-terminous with the lateral edges of the elongate metal substrate, i.e. the width of each oriented protective film is the same as the width of the elongate metal substrate. Thus, advantageously the entire surface area of both upper and lower surfaces of the metal substrate is protected by oriented protective film, in particular by first and second discrete oriented protective films on the respective upper and lower surfaces.

In a third and particularly preferred embodiment, a first oriented heat-sealable polymeric protective film comprising an oriented polymeric substrate layer and a heat-sealable polymeric layer is disposed on an indicia-bearing and optionally pigmented upper surface of the elongate metal substrate such that said oriented polymeric substrate layer constitutes the exterior upper surface of the blade of the tape measure (i.e. it is exposed to the environment in use) and the polymeric heat-sealable layer is innermost (i.e. it faces the upper surface of the metal substrate), and wherein said first oriented heat-sealable polymeric protective film is wrapped around each lateral edge of said upper surface of the elongate metal substrate such that a portion of said first oriented heat-sealable protective film at each of its lateral edges is disposed on the lower surface of the blade. In this embodiment, said blade comprises a second oriented polymeric protective film disposed on the lower surface of the elongate metal substrate, preferably wherein said portions of the first oriented polymeric protective film which are disposed on said lower surface overlap with said second oriented polymeric protective film such that said portions of the first oriented polymeric protective film form at least part of the exterior lower surface.

In the third embodiment, the lower surface of the elongate metal substrate may bear measurement indicia, and is optionally pigmented.

In this third embodiment, an adhesive layer is preferably interposed between the upper surface of the elongate metal substrate and the first oriented protective film, and between the lower surface of the elongate metal substrate and the second oriented polymeric protective film.

Thus, in this third embodiment, the layer order is preferably: first oriented heat-sealable polymeric protective film (in which the oriented polymeric substrate layer is outermost and the heat-sealable polymeric layer is innermost)/adhesive layer/indicia-bearing and optionally pigmented upper surface of the metal substrate/metal substrate/optionally indicia-bearing and optionally pigmented lower surface of the metal substrate/adhesive layer/second oriented polymeric protective film/portions of the first oriented heat-sealable protective film which have been wrapped around the lateral edges of the elongate metal substrate and disposed on at least part of the lower surface of the blade (wherein the oriented polymeric substrate layer is outermost and the heat-sealable polymeric layer is innermost).

Thus, advantageously not only the entire surface area of both upper and lower surfaces of the metal substrate, but also its lateral edges, are protected by oriented protective film. In this preferred embodiment, therefore, the vulnerable seams where the lateral edges of the oriented protective film meet the metal substrate are not exposed to the environment or mechanical stress, thereby improving the delamination resistance of the protective film and the durability of the tape measure.

In the third embodiment, it will be appreciated that the width of the second protective oriented film disposed on said lower surface is no wider than the width of the elongate metal substrate. Preferably the second protective oriented film has the same width as the elongate metal substrate. Alternatively, the second protective oriented film may have a width which is slightly narrower than that of the elongate metal substrate, and preferably no less than 90%, more preferably no less than 95%, preferably no less than 98% of the width of the elongate metal substrate.

In the third embodiment, the first oriented protective film is required to be heat-sealable because, when it is wrapped around the lateral edges of the elongate metal substrate, a high seal strength is required between the protective film and the lower surface of the elongate metal substrate in order to retain the wrapped film in position.

In the third embodiment, the first oriented protective film is preferably the oriented polyamide protective film as described hereinabove, i.e. an oriented polyamide protective film comprising an oriented polyamide substrate layer and a heat-sealable polymeric coating layer.

In this third embodiment, particularly wherein the lower surface of the elongate metal substrate bears measurement indicia, the second oriented polymeric protective film is preferably an oriented polyamide protective film as hereinbefore described. In that case, the first and second oriented polyamide protective films may be the same or different. Because the second oriented polyamide protective film is not wrapped around the lateral edges of the metal substrate, however, a polymeric heat-sealable layer is optional. In a preferred embodiment, the first and second oriented polyamide protective films have the same composition, and preferably also the same thickness.

Alternatively, and particularly wherein the lower surface does not bear measurement indicia, the second oriented polymeric protective film of the third embodiment may be a polyester film, preferably polyethylene terephthalate (PET) film, preferably a biaxially oriented PET film. Said polyester film may be a composite film which comprises a polymeric heat-sealable layer disposed on one or both surface(s) of an oriented polyester substrate layer, as described hereinabove.

Preferably, said first and second protective films are configured such that a heat-sealable coating layer which is heat-sealed to a polyamide surface (particularly an umprimed polyamide surface) is selected from an EVA polymeric heat-sealable layer. Thus, a first protective film which is wrapped around the lateral edges of the elongate metal substrate such its heat-sealable coating layer is contacted with such a polyamide surface is preferably a protective film which comprises an oriented polyamide or polyester substrate layer and an EVA polymeric heat-sealable layer, as described herein.

In a particularly preferred configuration of the third embodiment, hereinafter referred to as embodiment 3A, each of said first oriented polymeric protective film and said second oriented polymeric protective film is an oriented polyamide protective film as described hereinabove, i.e. an oriented polyamide protective film comprising an oriented polyamide substrate layer and a heat-sealable polymeric coating layer. The first oriented polyamide protective film is disposed as described above, i.e. such that said oriented polyamide substrate layer constitutes the exterior upper surface of the blade of the tape measure (i.e. it is exposed to the environment in use) and the polymeric heat-sealable layer is innermost (i.e. it faces towards the upper surface of the metal substrate). However, the second oriented polyamide protective film is disposed such that the oriented polyamide substrate layer is innermost (i.e. it faces towards the lower surface of the metal substrate) and the polymeric heat-sealable layer faces outwards. In this way, in respect of the portions of said first protective film which are wrapped around the blade and disposed on the lower surface, the heat-sealable layer of the first protective film is contacted with the heat-sealable layer of the second protective film, thereby forming a particularly strong heat-seal bond. In this embodiment 3A, the heat-sealable polymeric coating layer is preferably selected from PVDC and EVA, preferably PVDC.

In a further preferred configuration of the third embodiment, hereinafter referred to as embodiment 3B, said first oriented polymeric protective film is an oriented polyamide protective film as described hereinabove, i.e. an oriented polyamide protective film comprising an oriented polyamide substrate layer and a heat-sealable polymeric coating layer, and disposed as described for embodiment 3A. The second oriented polymeric protective film is selected from polyester film, preferably biaxially oriented PET film, which is preferably a composite film comprising a polymeric heat-sealable layer disposed on one or both surface(s) of an oriented polyester substrate layer, preferably wherein the heat-sealable polymeric layer is selected from the heat-sealable polymeric layers disclosed hereinabove. In this embodiment 3B, the heat-sealable polymeric coating layer(s) on each of the first and second protective films is preferably selected from PVDC and EVA, preferably PVDC.

In a further preferred configuration of the third embodiment, hereinafter referred to as embodiment 3C, said first oriented polymeric protective film is an oriented polyester protective film as described hereinabove, i.e. an oriented polyester protective film comprising an oriented polyester substrate layer (preferably a biaxially oriented PET film) and a heat-sealable polymeric coating layer, and disposed as described for embodiment 3A. The heat-sealable polymeric coating layer is selected from EVA. The second oriented polymeric protective film is an oriented polyamide protective film as described hereinabove comprising an oriented polyamide substrate layer and a heat-sealable polymeric coating layer (preferably selected from PVDC and EVA, preferably PVDC), and disposed such that the polymeric heat-sealable layer is innermost, i.e. it faces towards the lower surface of the metal substrate.

In a further preferred configuration of the third embodiment, hereinafter referred to as embodiment 3D, said first oriented polymeric protective film is an oriented polyester protective film as described hereinabove, i.e. an oriented polyester protective film comprising an oriented polyester substrate layer (preferably a biaxially oriented PET film) and a heat-sealable polymeric coating layer, and disposed as described for embodiment 3A. The heat-sealable polymeric coating layer is selected from EVA. The second oriented polymeric protective film is an oriented polyamide protective film without a heat-sealable polymeric coating layer. In other words, the oriented polyamide protective film is as described above for the oriented polyamide substrate layer, and optionally comprises a primer layer which, where present is innermost, i.e. it faces towards the lower surface of the metal substrate.

In a further preferred configuration of the third embodiment, hereinafter referred to as embodiment 3E, said first oriented polymeric protective film is an oriented polyester protective film as described hereinabove, i.e. an oriented polyester protective film comprising an oriented polyester substrate layer (preferably a biaxially oriented PET film) and a heat-sealable polymeric coating layer, and disposed as described for embodiment 3A. The heat-sealable polymeric coating layer is selected from PVDC. The second oriented polymeric protective film is an oriented polyamide protective film as described hereinabove, i.e. an oriented polyamide protective film comprising an oriented polyamide substrate layer and a heat-sealable polymeric coating layer (preferably selected from PVDC and EVA, preferably PVDC), and disposed such that the oriented polyamide substrate layer is innermost, i.e. it faces towards the lower surface of the metal substrate, and the polymeric heat-sealable layer faces outwards and thereby being in contact with the heat-sealable layer of the first protective film, thereby forming a particularly strong heat-seal bond.

In each of embodiments 3A to 3E, the thickness of each of the first and second protective films is as described above and preferably no more than 15 μm. In each of embodiments 3A to 3E, an oriented polyamide protective film preferably further comprises a primer layer disposed between said oriented polyamide substrate layer and said heat-sealable polymeric coating layer disposed thereon, as described hereinabove.

The blade of the tape measure of the present invention preferably has a total thickness of no more than 300 μm, preferably no more than 250 μm.

Advantageously, the tape measure blade disclosed herein exhibits excellent or improved abrasion resistance while decreasing the thickness of the blade, thereby allowing the dimensions of the housing to be reduced for any particular length of blade. Moreover, the preferred tape measure blade disclosed herein exhibits excellent or improved delamination resistance between the protective film and the metal substrate.

Conventionally, the manufacture of tape measures has utilised films having an adhesive layer, for instance pressure-sensitive adhesive layers, which are inherently tacky and which can attract debris during manufacture of the film and the tape. Such accumulated debris can reduce the legibility of the measurement indicia displayed on the blade making the indicia difficult or impossible to read which can lead to inaccuracies in measurement. Additionally, accumulated debris can interfere with the retraction and rewinding of the tape. Advantageously, the polymeric protective film having a heat-sealable polymeric coating layer as described hereinabove overcomes those problems because the heat-sealable layer is not tacky at room temperature when exposed to the environment during manufacture, since its bonding properties are only activated at the higher temperatures experienced during the lamination step, at which point the heat-sealable surface is already in contact with the substrate to which it will be bonded. Accordingly, the presence of the heat-sealable polymeric coating layer in the protective film reduces or eliminates the problem of accumulated debris.

The blade of the invention may be incorporated into any tape measure design, including those conventional in the art, for instance as represented by the tape measure disclosed in US-2007/0079520-A, and manufactured using known techniques.

According to a second aspect of the invention, there is provided a tape measure comprising a housing for retaining a blade and a blade according to the first aspect of invention described hereinabove. It will be appreciated that the entirety of the description of the first aspect of the invention, including the preferences and embodiments, is equally applicable to the second aspect of the invention.

According to a third aspect of the invention, there is provided a blade for a tape measure comprising an elongate metal substrate having an upper surface and a lower surface, wherein measurement indicia are disposed on at least one of said upper and lower surfaces, wherein said blade further comprises a first oriented protective film disposed on the upper surface and a second oriented protective film disposed on the lower surface, wherein at least one and preferably both of said oriented protective film(s) is an oriented polyamide film, wherein the thickness of said oriented protective film is no more than 20 μm, preferably no more than 15 μm, preferably no more than 12.5 μm, and wherein the width of each of said oriented protective films is the same as the width of the elongate metal substrate.

In the third aspect of the invention, said oriented polyamide film does not comprise a heat-sealable layer. The oriented polyamide film optionally comprises a primer layer in order to facilitate adhesion to the aforementioned adhesive layers. Otherwise, the description of the first aspect of the invention, including the preferences and embodiments, is equally applicable to the third aspect of the invention.

According to a fourth aspect of the invention, there is provided a tape measure comprising a housing for retaining a blade and a blade according to the third aspect of invention described hereinabove. It will be appreciated that the entirety of the description of the third aspect of the invention, including the preferences and embodiments, are equally applicable to the fourth aspect of the invention.

The invention is further illustrated with reference to the figures, as described below.

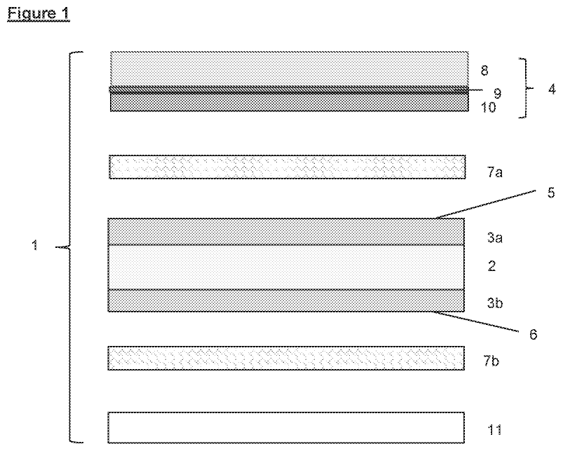

FIG. 1 is schematic cross-section across the long dimension of a blade (1) according to the present invention illustrating the layer structure. The metal substrate (2) has optionally pigmented indicia-bearing layers (3a, 3b) disposed thereon. A first oriented polyamide protective film (4) is disposed on an upper indicia-bearing pigmented surface (5) of the metal substrate, via an intervening layer of adhesive (7a). Oriented polyamide protective film (4) is made of oriented polyamide substrate layer (8), primer layer (9) and heat-sealable layer (10). A second oriented protective film (11) is disposed on the lower optionally indicia-bearing and pigmented surface (6) of the metal substrate, via an intervening layer of adhesive (7b).

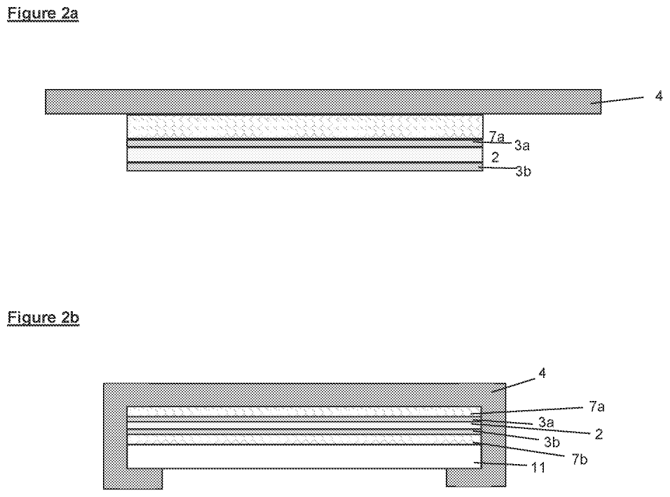

FIGS. 2a and 2b illustrate schematic cross-sections across the long dimension of a blade (1) according to the present invention showing the preferred wrapped structure. The blade comprises metal substrate (2) having optionally pigmented indicia-bearing layers (3a, 3b) disposed thereon. A first oriented protective film (4) is disposed on the upper indicia-bearing surface of the metal substrate (2), via an intervening layer of adhesive (7a). The lateral edges of the protective film (4) are wrapped around the lateral edges of the metal substrate (2), and adhered to the lower indicia-bearing surface of the metal substrate (2). A second oriented protective film (11) is disposed on the lower indicia-bearing surface of the metal substrate (2), via intervening layer of adhesive (7b). FIG. 2a shows the oriented protective film (4) upon application to the indicia-bearing metal substrate (2), and FIG. 2b shows the final laminated structure.

Measurement Methods

The films disclosed herein are characterised by the following test methods.

(i) Heat seal strength was determined as follows. One half of an A4 sheet of film comprising a substrate layer and a heat-sealable coating layer was sealed to itself (coated side to coated side) using a Sentinel heat sealer (Model 12 by Packaging Industries Group Inc.). The heat sealer was operated for 0.5 seconds at 207 kPa (30 psi) with a 150° C. top jaw and a 40° C. bottom jaw. The sealed sample was marked and cut into 25 mm width strips, the folded portion was slit and the heat seal strength was determined by peel strength testing on an INSTRON® model 4464 test machine. The jaws were set 50 mm apart. The upper jaw held one piece of the sealed sample and travelled up at a speed of 250 mm/min, while the lower jaw held the other piece of the sealed sample and was stationary. The maximum force needed to separate the two pieces of film was recorded. Three sealed sample pieces were measured for each coated sample.

The invention is further illustrated by the following examples. It will be appreciated that the examples are for illustrative purposes only and are not intended to limit the invention as described above. Modification of detail may be made without departing from the scope of the invention.

### EXAMPLES

In the following examples, a PVDC heat-sealable coating composition was prepared by dissolving 16 g of PVDC (R204, Asahi Kasei) in 82 g of a mixture of toluene and THF (weight ratio: 20/80) at 50° C., followed by adding 0.8 g of minor coating ingredients of slip additive and anti-blocking agent. The PVDC coating composition was coated using a Meyer coating rod (coating weight, 2.5 g/m2). The coated film was transferred to a forced air oven preset to 90° C. for dried for 3 minutes.

### Example 1

A tape measure blade was manufactured by coating an elongate metal substrate with a yellow pigment layer on the upper and lower surfaces thereof, and subsequently disposing measurement indicia on its upper surface only. An oriented protective film (the second protective film referred to herein) having the same width as the elongate metal substrate was disposed on the lower surface of the pigmented metal substrate by applying a layer of aqueous-based polyurethane adhesive on said pigmented metal substrate and then disposing the oriented protective film on the adhesive layer. A further adhesive layer was disposed on the indicia-bearing and pigmented upper surface of the metal substrate, and a further oriented protective film (the first protective film referred to herein) having a width wider than the elongate metal substrate was disposed on the adhesive layer. The lateral portions of the first protective film were wrapped around the lateral edges of the elongate metal substrate and contacted with the external surface of the second protective film on the lower surface of the blade. The blade assembly was laminated by application of heat and pressure (170° C.; 180 kPa) via nip rollers.

Each of the first and second protective films was a coated biaxially oriented polyamide heat-sealable film made up of a primer-coated biaxially oriented nylon 6 substrate layer (12 μm thick; Capran®1200M available from AdvanSix) and PVDC heat-sealable coating layer (1.3 μm thick) prepared as described above which was disposed on the primed surface of the nylon substrate layer. The first protective film was disposed with the nylon substrate layer constituting the external surface of the upper surface of the finished blade. The second protective film was disposed with the nylon substrate layer contacting the adhesive layer on the lower surface of the pigmented metal substrate.

The peel strength (coating to coating) of the coated biaxially oriented polyamide heat-sealable film was 11 g/mm, measured as described herein.

The tape measure blade exhibited excellent durability and abrasion resistance in use.

### Example 2

The procedure of Example 1 was repeated except that the second protective film was made up of a biaxially oriented PET substrate layer (12.5 μm thick) and a PVDC heat-sealable coating layer (1.3 μm thick) on one surface thereof. The second protective film was disposed with the PVDC layer contacting the adhesive layer on the lower surface of the pigmented metal substrate.

### Example 3

The procedure of Example 1 was repeated except that the second protective film was made up of a biaxially oriented PET substrate layer (12.5 μm thick) and a PVDC heat-sealable coating layer (1.3 μm thick) on both surfaces thereof.

### Example 4

The procedure of Example 1 was repeated except that the second protective film was made up of a biaxially oriented PET substrate layer (12.5 μm thick).

### Example 5

The procedure of Example 1 was repeated except that the first protective film was made up of a biaxially oriented primed PET substrate layer (12.5 μm thick; the primer layer being a PVDC coating layer less than 1 μm thick) and an EVA (Elvax® 3180; DuPont) heat-sealable coating layer (3.0 μm thick) coated on the primed surface thereof. The first protective film was disposed such that the PET substrate layer constituted the external upper surface of the blade. In addition, the second protective film was the same as in Example 1 except that the film was instead disposed with the PVDC layer contacting the adhesive layer on the lower surface of the pigmented metal substrate.

### Example 6

The procedure of Example 1 was repeated except that the first protective film was made up of a biaxially oriented PET substrate layer (12.5 μm thick) and a PVDC heat-sealable coating layer (1.3 μm thick) on one surface thereof. The first protective film was disposed such that the PET substrate layer constituted the external upper surface of the blade. The second protective film was disposed the same way as in Example 1, i.e. with the nylon substrate layer contacting the adhesive layer on the lower surface of the pigmented metal substrate.

### Example 7

The procedure of Example 1 was repeated except that the first protective film was made up of a biaxially oriented primed PET substrate layer (12.5 μm thick) and an EVA (Elvax® 3180; DuPont) heat-sealable coating layer (3.0 μm thick) on the primed surface thereof. The first protective film was disposed such that the PET substrate layer constituted the external upper surface of the blade. In addition, the second protective film instead consisted of a primer-coated biaxially oriented nylon 6 substrate layer (12 μm thick; Capran®1200M available from AdvanSix). The second protective film was disposed with the primer layer contacting the adhesive layer on the lower surface of the pigmented metal substrate.

### Example 8

The procedure of Example 1 was repeated except that the first protective film was made up of a biaxially oriented primed PET substrate layer (12.5 μm thick) and an EVA (Elvax® 3180; DuPont) heat-sealable coating layer (3.0 μm thick) on the primed surface thereof. The first protective film was disposed such that the PET substrate layer constituted the external upper surface of the blade. In addition, the second protective film instead consisted of an unprimed nylon 6 substrate layer (12 μm thick).

1. A blade for a tape measure comprising an elongate metal substrate having an upper surface and a lower surface, wherein measurement indicia are disposed on at least one of said upper and lower surfaces, wherein said blade further comprises an oriented polyamide protective film disposed on at least one surface of said upper and lower surfaces, wherein the oriented polyamide protective film comprises an oriented polyamide substrate layer and a heat-sealable polymeric coating layer, and wherein the thickness of said oriented polyamide protective film is no more than 75 μm.

2. A blade according to claim 1 wherein a pigment or paint layer is disposed on the metal substrate prior to application of the measurement indicia.

3. A blade according to any preceding claim wherein said polyamide is a thermoplastic crystallisable linear aliphatic polyamides, preferably selected from: nylon 6,6; nylon 6; nylon 6.66; nylon 6,10; nylon 6,4; and blends and mixtures thereof.

4. A blade according to any preceding claim wherein said oriented polyamide protective film is biaxially oriented.

5. A blade according to any preceding claim wherein the thickness of said oriented polyamide protective film is no more than 50 μm, preferably no more than 25.0 μm, preferably no more than 20 μm, preferably no more than 15 μm, preferably no more than 12.5 μm.

6. A blade according to any preceding claim wherein the oriented polyamide protective film comprises an oriented polyamide substrate layer and a heat-sealable polymeric coating thereon.

7. A blade according to claim 6 wherein the heat-sealable polymeric coating is formed from a polymeric material selected from polyvinylidene chloride (PVDC), ethylene vinyl acetate (EVA), polyolefins, ethylene-acrylic acid copolymers, ethylene-methacrylic acid copolymers and copolyesters, preferably from EVA and PVDC.

8. A blade according to claim 6 or 7 wherein the heat-sealable coating is formed from EVA polymer having a vinyl acetate content in the range of 9% to 40%.

9. A blade according to claim 6 or 7 wherein the heat-sealable coating is formed from a copolyester derived from an aromatic dicarboxylic acid and an aliphatic dicarboxylic acid having the general formula CₙH₂ₙ(COOH)₂ wherein n is 2 to 8, and one or more aliphatic diol(s), preferably wherein the aromatic dicarboxylic acid is terephthalic acid, the aliphatic dicarboxylic acids are selected from sebacic acid, adipic acid and azelaic acid, and the aliphatic diols are selected from ethylene glycol or butylene glycol.

10. A blade according to claim 9 wherein the concentration of the aromatic dicarboxylic acid present in the copolyester is in the range from 45 to 80, more preferably 50 to 70, and particularly 55 to 65 mole % based on the dicarboxylic acid components of the copolyester; and the concentration of the aliphatic dicarboxylic acid present in the copolyester is in the range from 20 to 55, more preferably 30 to 50, and particularly 35 to 45 mole % based on the dicarboxylic acid components of the copolyester.

11. A blade according to claim 9 or 10 wherein the copolyesters are selected from:
(i) copolyesters of azeleic acid and terephthalic acid with an aliphatic glycol, preferably ethylene glycol, preferably a copolyester of azeleic acid/terephthalic acid/ethylene glycol having the components in the relative molar ratios of 40-50/60-50/100 and more preferably 45/55/100.
(ii) copolyesters of adipic acid and terephthalic acid with an aliphatic glycol, preferably ethylene glycol; and
(iii) copolyesters of sebacic acid and terephthalic acid with an aliphatic glycol, preferably butylene glycol, preferably a copolyester of sebacic acid/terephthalic acid/butylene glycol, preferably having the components in the relative molar ratios of 45-55/55-45/100 and more preferably 50/50/100.

12. A blade according to any of claims 6 to 11 wherein a primer coating layer is disposed between the oriented polyamide substrate and the heat-sealable coating layer, preferably wherein said primer coating is selected from polyurethanes, polyethyleneimines and PVDC.

13. A blade according to any of claims 6 to 12 wherein the thickness of the heat-sealable coating layer is from about 0.5 to about 5 μm, preferably from 1 to about 4 μm, and the thickness of the optional primer layer is no more than 1 μm, preferably no more than about 0.5 μm, preferably no more than about 0.3 μm, preferably at least 0.05 μm, and typically about 0.1 μm.

14. A blade according to any of claims 6 to 13 wherein said oriented polyamide protective film comprises, consists essentially of or consists of an oriented polyamide substrate layer, an optional primer coating layer and a heat-sealable coating layer, preferably wherein the oriented polyamide protective film is disposed on the elongate metal substrate such that the oriented polyamide substrate layer forms the exterior surface of the blade of the tape measure.

15. A blade according to any preceding claim wherein a layer of adhesive is interposed between the oriented protective film and the elongate metal substrate, preferably wherein the adhesive is copolyester or polyurethane adhesive, preferably wherein the thickness of the adhesive layer is in the range of from 5 to 10 μm.

16. A blade according to any preceding claim which comprises a first oriented protective film on the upper surface of the elongate metal substrate and a second oriented protective film on the lower surface of the elongate metal substrate, wherein:
(i) one of said first and second oriented protective films is selected from said oriented polyamide protective film comprising an oriented polyamide substrate layer and a heat-sealable polymeric coating layer, and
(ii) the other of said first and second oriented protective films is selected from an oriented polyamide protective film, such as said oriented polyamide protective film comprising an oriented polyamide substrate layer and a heat-sealable polymeric coating layer, or is selected from an oriented polyester protective film, preferably a polyethylene terephthalate (PET) film, preferably a biaxially oriented PET film.

17. A blade according to any of claims 1 to 15 wherein the blade is constituted by an elongate metal substrate having measurement indicia disposed on the optionally pigmented upper surface thereof, a layer of adhesive disposed on said indicia-bearing surface, and said oriented polyamide protective film disposed on said adhesive layer, wherein the heat-sealable polymeric coating layer of said oriented polyamide protective film is in direct contact with said adhesive layer.

18. A blade according to claim 17 wherein the blade further comprises a second layer of adhesive disposed on the optionally pigmented and optionally indicia-bearing lower surface of the elongate metal substrate, and a second oriented protective polymeric film disposed on said second adhesive layer.

19. A blade according to claim 18 wherein said second oriented protective polymeric film is selected from an oriented polyamide protective film, such as said oriented polyamide protective film comprising an oriented polyamide substrate layer and a heat-sealable polymeric coating layer wherein the heat-sealable polymeric coating layer is in direct contact with said second adhesive layer, or is selected from an oriented polyester protective film, preferably a polyethylene terephthalate (PET) film, preferably a biaxially oriented PET film optionally wherein said polyester film comprises a polymeric heat-sealable layer disposed on one surface thereof such that the polymeric heat-sealable layer is in direct contact with said second adhesive layer.

20. A blade according to any of claims 1 to 16 wherein the blade is constituted by an elongate metal substrate having measurement indicia disposed on the optionally pigmented upper surface thereof, a first layer of adhesive disposed on said indicia-bearing upper surface, a first oriented protective film disposed on said first adhesive layer, a second layer of adhesive disposed on the optionally pigmented and optionally indicia-bearing lower surface of said elongate metal substrate, and a second oriented protective film disposed on said second adhesive layer, wherein said second oriented protective film is an oriented protective polyamide film comprising a heat-sealable polymeric coating layer, wherein said heat-sealable polymeric coating layer of said second oriented polyamide protective film is in direct contact with said second adhesive layer.

21. A blade according to claim 20 wherein said first oriented protective polymeric film is selected from an oriented polyamide protective film, such as said oriented polyamide protective film comprising an oriented polyamide substrate layer and a heat-sealable polymeric coating layer wherein the heat-sealable polymeric coating layer is in direct contact with said first adhesive layer, or is selected from an oriented polyester protective film, preferably a polyethylene terephthalate (PET) film, preferably a biaxially oriented PET film, optionally wherein said polyester film comprises a polymeric heat-sealable layer disposed on one surface thereof such that the polymeric heat-sealable layer is in direct contact with said first adhesive layer.

22. A blade according to any of claims 17 to 21 wherein the lateral edges of the or each oriented protective polymeric film are co-terminous with the lateral edges of the elongate metal substrate.

23. A blade according to any of claims 1 to 16 wherein the blade is constituted by a first oriented heat-sealable polymeric protective film comprising an oriented polymeric substrate layer and a heat-sealable polymeric layer, wherein said first protective film is disposed on an indicia-bearing and optionally pigmented upper surface of the elongate metal substrate such that said oriented polymeric substrate layer constitutes the exterior upper surface of the blade of the tape measure, and wherein said first oriented heat-sealable polymeric protective film is wrapped around each lateral edge of said upper surface of the elongate metal substrate such that a portion of said first oriented heat-sealable protective film at each of its lateral edges is disposed on the optionally indicia-bearing and optionally pigmented lower surface of the blade.

24. A blade according to claim 23 which comprises a second oriented polymeric protective film disposed on the lower surface of the elongate metal substrate, wherein said portions of the first oriented polymeric protective film which are disposed on said lower surface overlap with said second oriented polymeric protective film such that said portions of the first oriented polymeric protective film form at least part of the exterior lower surface.

25. A blade according to claim 23 or 24 wherein an adhesive layer is interposed between the upper surface of the elongate metal substrate and the first oriented protective film, and where the blade comprises a second oriented polymeric protective film disposed on the lower surface then an adhesive layer is disposed between the lower surface of the elongate metal substrate and the second oriented polymeric protective film.

26. A blade according to any of claims 23 to 25 wherein the first oriented protective film is said oriented polyamide protective film comprising an oriented polyamide substrate layer and a heat-sealable polymeric coating layer.

27. A blade according to any of claims 23 to 26 wherein said second oriented protective polymeric film is selected from an oriented polyamide protective film, such as said oriented polyamide protective film comprising an oriented polyamide substrate layer and a heat-sealable polymeric coating layer wherein the heat-sealable polymeric coating layer is in direct contact with said second adhesive layer, or is selected from an oriented polyester protective film, preferably a polyethylene terephthalate (PET) film, preferably a biaxially oriented PET film optionally wherein said polyester film comprises a polymeric heat-sealable layer disposed on one surface thereof.

28. A blade according to any of claims 23 to 25 wherein each of said first oriented polymeric protective film and said second oriented polymeric protective film is an oriented polyamide protective film comprising an oriented polyamide substrate layer and a heat-sealable polymeric coating layer, wherein the first oriented polyamide protective film is disposed such that said oriented polyamide substrate layer constitutes the exterior upper surface of the blade of the tape measure and the polymeric heat-sealable layer is innermost, and wherein the second oriented polyamide protective film is disposed such that the oriented polyamide substrate layer is innermost and the polymeric heat-sealable layer faces outwards, wherein the portions of said first protective film which are wrapped around the blade and disposed on the lower surface are disposed such that the heat-sealable layer of the first protective film is contacted with the heat-sealable layer of the second protective film, preferably wherein the heat-sealable polymeric coating layer is selected from PVDC and EVA, preferably from PVDC.

29. A blade according to any of claims 23 to 25 wherein said first oriented polymeric protective film is an oriented polyamide protective film comprising an oriented polyamide substrate layer and a heat-sealable polymeric coating layer, wherein:
(i) said first oriented polyamide protective film is disposed such that said oriented polyamide substrate layer constitutes the exterior upper surface of the blade of the tape measure and the polymeric heat-sealable layer is innermost, and
(ii) said second oriented polymeric protective film is selected from polyester film, preferably biaxially oriented PET film, preferably a composite film comprising a polymeric heat-sealable layer disposed on one or both surface(s) of an oriented polyester substrate layer, preferably wherein the heat-sealable polymeric coating layer(s) on each of the first and second protective films is selected from PVDC and EVA, preferably PVDC.

30. A blade according to any of claims 23 to 25 wherein:
(i) said first oriented polymeric protective film is an oriented polyester protective film comprising an oriented polyester substrate layer (preferably a biaxially oriented PET substrate layer) and a heat-sealable polymeric coating layer selected from EVA, disposed such that said oriented polyester substrate layer constitutes the exterior upper surface of the blade of the tape measure and the polymeric heat-sealable layer is innermost, and:
(ii) said second oriented polymeric protective film is an oriented polyamide protective film comprising an oriented polyamide substrate layer and a heat-sealable polymeric coating layer which is preferably selected from PVDC and EVA, and disposed such that the polymeric heat-sealable layer is innermost.

31. A blade according to any of claims 23 to 25 wherein:
(i) said first oriented polymeric protective film is an oriented polyester protective film comprising an oriented polyester substrate layer, preferably a biaxially oriented PET film, and a heat-sealable polymeric coating layer selected from EVA, and disposed such that said oriented polyester substrate layer constitutes the exterior upper surface of the blade of the tape measure and the polymeric heat-sealable layer is innermost; and
(ii) said second oriented polymeric protective film is an oriented polyamide protective film without a heat-sealable polymeric coating layer.

32. A blade according to any of claims 23 to 25 wherein:
(i) said first oriented polymeric protective film is an oriented polyester protective film comprising an oriented polyester substrate layer, preferably a biaxially oriented PET film, and a heat-sealable polymeric coating layer selected from PVDC, and disposed such that said oriented polyester substrate layer constitutes the exterior upper surface of the blade of the tape measure and the polymeric heat-sealable layer is innermost;
(ii) said second oriented polymeric protective film is an oriented polyamide protective film comprising an oriented polyamide substrate layer and a heat-sealable polymeric coating layer preferably selected from PVDC and EVA, preferably PVDC, and disposed such that the oriented polyamide substrate layer is innermost, and the polymeric heat-sealable layer faces outwards and is in contact with the heat-sealable layer of the first protective film.

33. A blade according to any of claims 26 to 32 wherein the thickness of each of the first and second protective films is no more than 15 μm.

34. A blade according to any preceding claim which has a total thickness of no more than 300 μm.

35. A blade for a tape measure comprising an elongate metal substrate having an upper surface and a lower surface, wherein measurement indicia are disposed on at least one of said upper and lower surfaces, wherein said blade further comprises a first oriented protective film disposed on the upper surface and a second oriented protective film disposed on the lower surface, wherein at least one and preferably both of said oriented protective film(s) is an oriented polyamide film which does not comprise a heat-sealable layer, wherein the thickness of said oriented protective film is no more than 20 μm, preferably no more than 15 μm, preferably no more than 12.5 μm, and wherein the width of each of said oriented protective films is the same as the width of the elongate metal substrate.

36. A blade according to claim 35 wherein said first and second oriented polyamide films are selected from the oriented polyamide films defined in any of claims 3 to 14.

37. A blade according to claim 35 or 36 wherein a pigment or paint layer is disposed on the metal substrate prior to application of measurement indicia.

38. A blade according to claim 35, 36 or 37 wherein the blade is constituted by an elongate metal substrate having measurement indicia disposed on the optionally pigmented upper surface thereof, a first layer of adhesive disposed on said indicia-bearing surface, and said oriented polyamide protective film disposed on said first adhesive layer, wherein the heat-sealable polymeric coating layer of said oriented polyamide protective film is in direct contact with said first adhesive layer, and wherein a second layer of adhesive is disposed on the optionally pigmented and optionally indicia-bearing lower surface of the elongate metal substrate, and said second oriented protective polymeric film is disposed on said second adhesive layer wherein the heat-sealable polymeric coating layer of said second oriented polyamide protective film is in direct contact with said second adhesive layer, preferably wherein the thickness of an adhesive layer is in the range of from 5 to 10 μm.

39. A tape measure comprising a housing for retaining a blade and a blade according to any of claims 1 to 38.
